(19) United States
(12) Patent Application Publication
(10) Pub. No.: US 2026/0072450 A1
(43) Pub. Date: Mar. 12, 2026

(54) System and Method for Landmine Detection and Avoidance Using a Legged Robotic Platform

(71) Applicant: Ghost Robotics Corporation, Philadelphia, PA (US)

(72) Inventors: Jeff DUPERRET, Philadelphia, PA (US); Avik De, Philadelphia, PA (US)

(21) Appl. No.: 18/808,145

(22) Filed: Aug. 19, 2024

Related U.S. Application Data
(60) Provisional application No. 63/533,373, filed on Aug. 18, 2023.

(51) Int. Cl. G05D 1/689; G05D 1/622; G05D 105/85; G05D 109/12

(52) U.S. Cl. CPC G05D 1/689; G05D 1/622; G05D 2105/85; G05D 2109/12

(57) ABSTRACT

Systems and methods for landmine avoidance by using a legged robot platform are disclosed including mine detection equipment, a robotic arm, a legged robot capable of transporting that equipment to a site of interest to identify a potential location of a landmine.

Once a site of interest is identified, the robot may step over or actively avoid the designated area of interest.

### CROSS REFERENCE TO RELATED APPLICATIONS

This application claims the benefit of earlier filed U.S. Patent Application Serial No. 63/533,373, filed Aug. 18, 2023, the entire contents of which are hereby incorporated by reference.

### BACKGROUND OF THE INVENTION

The present invention is directed to landmine detection and avoidance using a legged robotic platform. The ability to automate the detection of landmines in hostile environments is critical to the future of human safety. While handheld detectors, systems that use wheeled or vehicle driven methods, and quasi-static legged systems are currently available, the use of dynamic legged robots for mine detection, marking, and avoidance presents unique advantages over these systems.

Demining with robotic systems can involve either flagging the location of a detected mine or intentionally detonating it. While a system that uses wheels for locomotion can navigate to an area where the landmine may be detected, the wheeled vehicle may have significant difficulty navigating around the detected mine after identification due to the non-holonomic nature of typical wheeled systems. This may result in inadvertent triggering of a landmine when only flagging was intended. On the other hand, if intentional detonation is desired, it may be desirable to control the pressure applied on the ground, an advantage that current wheeled systems may lack in precision.

Quasi-static legged robots suffer from slower speeds that inhibit clearing speed as well as poor energetic efficiency which limits operational use. In contrast, a dynamical legged robot, in accordance with the present invention, has the unique ability to both quickly and efficiently navigate terrain where a landmine might exist, as well as step over and avoid that landmine after identification because, unlike a wheeled or tracked robot, a legged robot does not need a continuous base of support to locomote.

The present invention represents a significant advantage for a legged robotic system in that it improves the efficiency of detection and potentially expedites the clearing of a minefield; allowing for safer navigation around the dangerous objects, more accurate mapping of a given area, and increases the likelihood of system survival.

### SUMMARY OF THE INVENTION

This method applies to a legged robot with one or more legs, equipped with a manipulator arm. The arm should have the ability to have a mine detector payload attached to it. The legged robot may be equipped with a “foot placement controller” that allows it to select desired footholds and locomote stably while the feet are placed.

Robotic manipulation is used in several application domains where a tool needs to interact with, or be placed near, an object. Such a tool placed at the distal portion of a robotic manipulator is referred to as an “end-effector. ” In different application areas, the end-effector may be quite different in terms of size or weight and may also require a different number of degrees of freedom to be actuated. The present invention provides an end-effector with landmine detecting capabilities.

To avoid stepping on identified mine locations, the legged robot can place virtual stepping obstacles around the danger area. These regions will be added as obstacles to the free space previously assumed to be available for foothold selection. An algorithm can modify the nominal footholds to move them out of the danger regions. This may be done by selecting the closest point that is outside the danger region. If the robot has more than one swinging foot (whose placement location needs to be simultaneously selected), the algorithm can pick the closest point using some metric in the combined configuration space of the two feet. The balance algorithm for the legged robot accounts for the modified foothold locations while planning its interaction forces with the ground.

On the other hand, if intentional detonation is desired, legged robots can select to apply excess pressure at a certain foothold location while maintaining balance by shifting the center of pressure, or by impulsively stomping.

To detect a mine, the robot can utilize its arm to sweep the mine detector over the ground while moving utilizing its legs. Such movement may require whole-body control where the generated leg forces take into account the forces generated in sweeping the mine detector so as to effectively balance the robot. In the case of unexpected collisions with the environment, the robot can proprioceptively detect these forces for a class of such forces account for them without falling over.

The sweeping movement of the mine detector on the arm should avoid colliding the mine detector with the ground or any obstacles but should also be kept at an appropriate height above the terrain. Such a system may need to differentiate between hard obstacles such as rocks which must be avoided, and brush such as tall grass which the arm may sweep through. Once a mine is detected the operator may choose to safely detonate it utilizing the robot's legs to stomp the ground on top of the detected location. This sacrifices the robot to detonate the mine when people are kept a safe distance away.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The various embodiments are illustrated by way of example, and not by way of limitation, in the figures of the accompanying drawings. Having thus described the invention in general terms, reference will now be made to the accompanying drawings, which are not necessarily drawn to scale, and wherein:

FIG. 1 depicts a legged robot.

FIG. 2 depicts a robotic arm in a seven (7) degrees of freedom (“DoF”) with gripper and 6-DoF without gripper configuration.

FIG. 3 shows a flowchart of typical demining operation.

FIG. 4 shows possible sweeping motion of robot with arm and mine detector.

FIG. 5 depicts the robot's movement through a terrain with at least one landmine detected.

FIG. 6 depicts the robot's movement during detection of soft obstacles and solid obstacles.

FIG. 7 depicts several components of the present invention.

### DETAILED DESCRIPTION OF THE PREFERRED EMBODIMENT

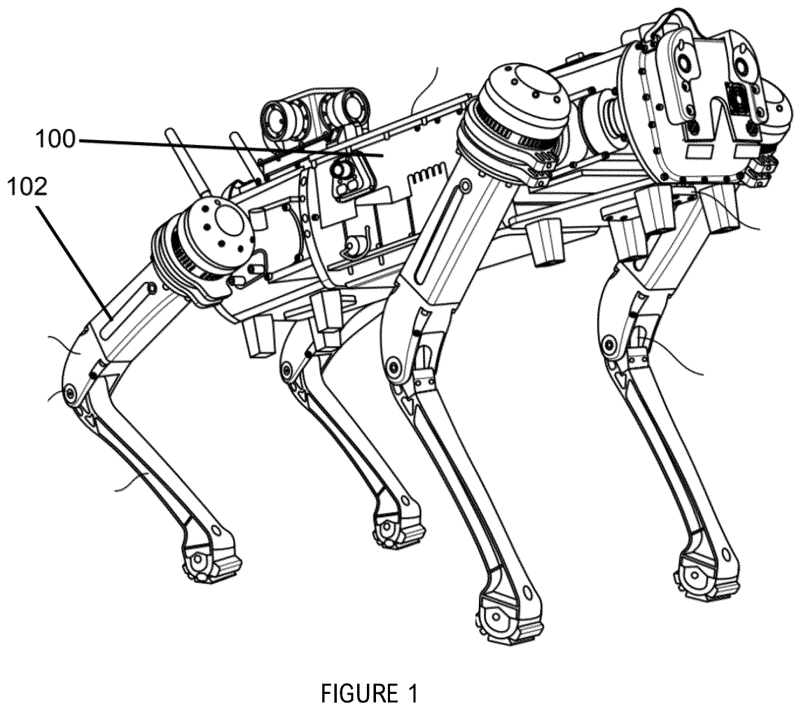

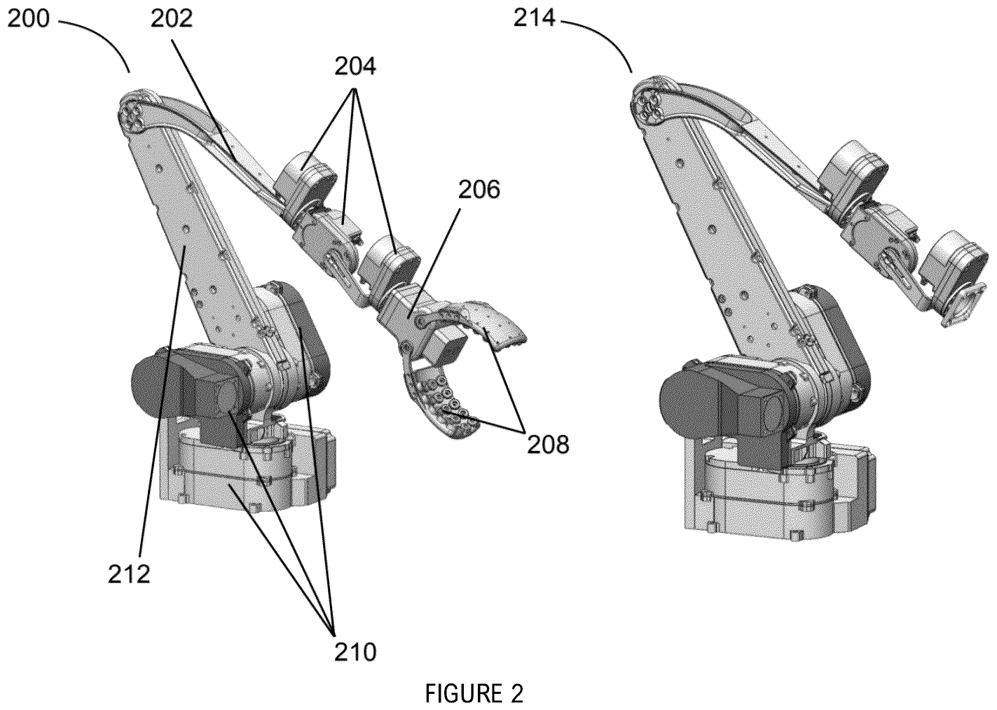

FIG. 1 depicts a legged robot. In accordance with the preferred embodiment of the present invention, a robot with at least one leg, for example and not by way of limitations, a robot with four legs, is manipulated to traverse a terrain. The robot may have a base 100 with at least one leg 102 attached to the base 100. The robot may additionally have an end-effector (FIG. 2) attached to the base 100. In the preferred embodiment of the present invention, the end-effector may be configured to detect mines. The end-effector may be capable of moving in a sweeping motion to detect nearby mines in the terrain. The robot may be equipped with a “foot placement controller” configured to control the placement of each foot of the robot within a desired degree of precision. Controlling the foot placement may comprise controlling placement location, pressure, duration, and other aspects of foot placement. The robot may be capable of dynamic movement, which may be controlled by a user or higher-level decision-making entity or performed autonomously or semi-autonomously.

The mine detector may be of varying shape, size, and weight. The robot can dynamically account for moving this weight along a desired trajectory while walking by using control algorithms such as whole-body control. The user may be required to input information about the shape, size, and weight of the mine detector, or the robot can run an auto-calibration routine where it estimates this information itself.

FIG. 2 depicts a robotic arm in 7 degrees of freedom (“DoF”) with gripper and 6-DoF without gripper configurations. In accordance with the preferred embodiment of the present invention, the robot may have an end-effector with 7-DoF 200 with a gripper 206 attached at one end. The gripper 206 may have a claw or digits 208 capable of opening and closing in order to grab, hold, and release objects. The arm 200 may be attached to the robot at the shoulder 210 of the arm. In order to achieve 7-DoF, the arm 200 may have elbow and wrist joints. The elbow joint connects the upper arm 212 with the forearm 202. The wrist 204 connects the forearm 202 to the gripper 206. In an alternative embodiment, the arm 214 may have 6-DoF and may not have a gripper or any end-effector attached. In this embodiment, a mine-detecting device or devices may be attached at the wrist joint as an end-effector.

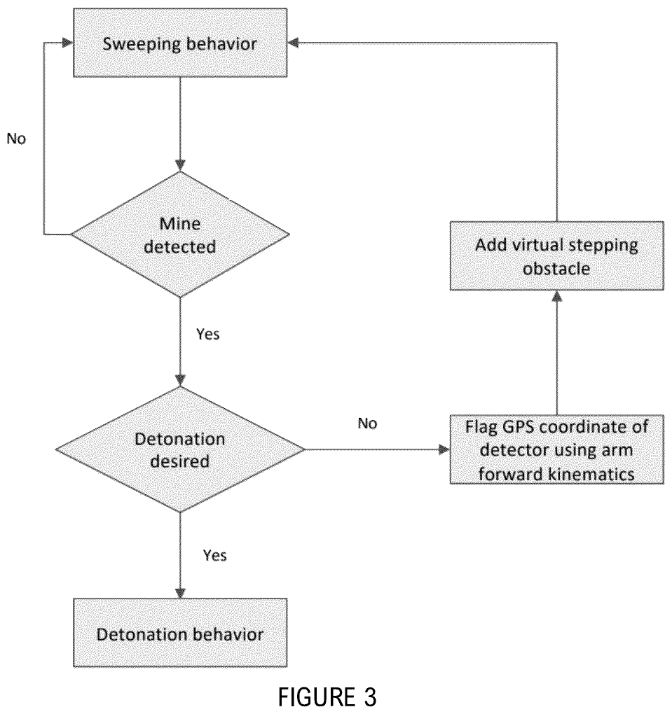

FIG. 3 shows a flowchart of typical demining operation. To begin, the user first communicates where to sweep to a dynamic legged robot equipped with a manipulator arm which has attached as an end effector a landmine detector. This could comprise anything from outlining a geo-fence on a map to manually directing or moving the robot base. In the case of more automated operation, the robot can navigate its way to the area of interest and formulate a path to cover the area with sweeps. In either case, the robot can be commanded to start sweeping once it reaches the desired location.

The robot can sweep the mine detector back and forth over the ground to increase sensor coverage as compared to holding the sensor statically in front of the robot. The robot can hold the sensor a set height above the ground, either sensing using exteroceptive data such as LiDar, projected light, or cameras; or proprioceptively by estimating the current ground plane and adjusting the height when collisions are felt through the arm. The path of the sweep with respect to the robot base, height of the detector above the ground, and frequency of the sweep can all be programmatically commanded from user input. The sweeping motion can be accomplished both while the robot base is stationary and while walking. In the case of unexpected collisions with the environment, the robot can proprioceptively detect these forces and for a class of such forces account for them without falling over. Such a height-maintaining control system may differentiate between hard obstacles such as rocks and other types the arm may sweep through, such as brush.

Once a landmine is detected, the robot can warn the user and can be capable of taking appropriate action such as moving away from the landmine or coming to a halt to avoid disturbing it. It can be capable of notifying the user of a detection event.

To avoid stepping on a mine after it has been detected - and also to avoid stepping on obstacles or terrain unsuitable for placing the weight of the robot on - the robot may be equipped with a foot placement controller that allows it to select desired footholds and locomote stably while the feet are placed there. Such footholds are selected to be dynamically feasible. Such operation allows the robot to navigate terrain dynamically in situations where a quasi-static legged robot might not successfully navigate.

Once a landmine has been detected it can be marked in the area of interest through the use of SLAM, GPS, or another method. These regions will be added as obstacles to the free space previously assumed to be available for foothold selection. An algorithm can modify the nominal footholds to move them out of the danger regions. This may be done by selecting the closest point that is outside the danger region. If the robot has more than one swinging foot (whose placement location needs to be simultaneously selected), the algorithm can pick the closest point using some metric in the combined (product) configuration space of the two feet, the balance algorithm for the legged robot accounts for the modified foothold locations while planning its interaction forces with the ground, while also accounting for the forces generated while actuating the sweeping mine detector.

At any time, the robot can pause sweeping. Once paused, the robot can more deliberately actuate the landmine detector to better investigate portions of the terrain within the workspace of the arm (or drive the robot base closer to those areas if needed), move the arm to a safe configuration, or completely stow the arm, among other actions.

After detecting a landmine, the robot can actively step around the detection area and continue its sweeping task in the direction of the desired path. The system can also avoid other landmine detections by using its control system and localization system to actively avoid stepping on any of those areas previously designated.

Once a landmine is detected, the operator may choose to safely detonate it utilizing the robot's legs to stomp the ground on top of the detected location. This sacrifices the robot to detonate the mine when people are kept a safe distance away. The force to generate this motion may be from hitting the object/ground with the arm end effector, from impacting it with one or more legs, or from using the whole body to impact it. The robot may jump in the air to achieve maximum impact force when delivering these forces, for example, to belly flop on to the detected mine.

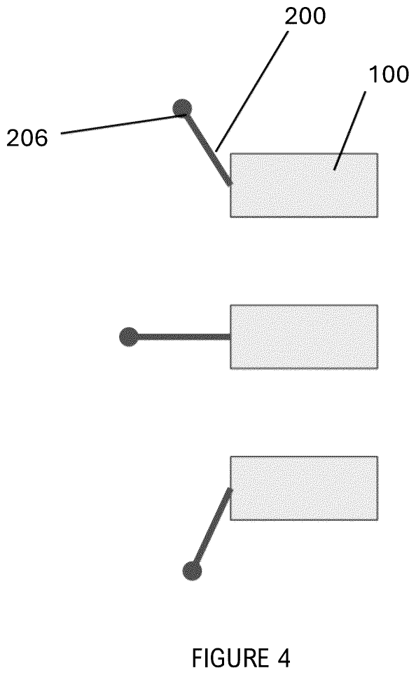

FIG. 4 shows possible sweeping motion of robot with arm and mine detector from a top view. In accordance with the preferred embodiment of the present invention, the arm 200 may move in a sweeping motion as depicted. The arm 200 may be attached to the base 100 of the robot. The arm 200 may have a gripper 206 or other end-effector attached. The arm 200, as depicted, may sweep across a front plane of the robot in order to detect mines as the robot advances forward. This ensures that any mines located in front of the robot are detected prior to the robot advancing onto the mine to decrease the likelihood of an accidental detonation of a mine prior to detection.

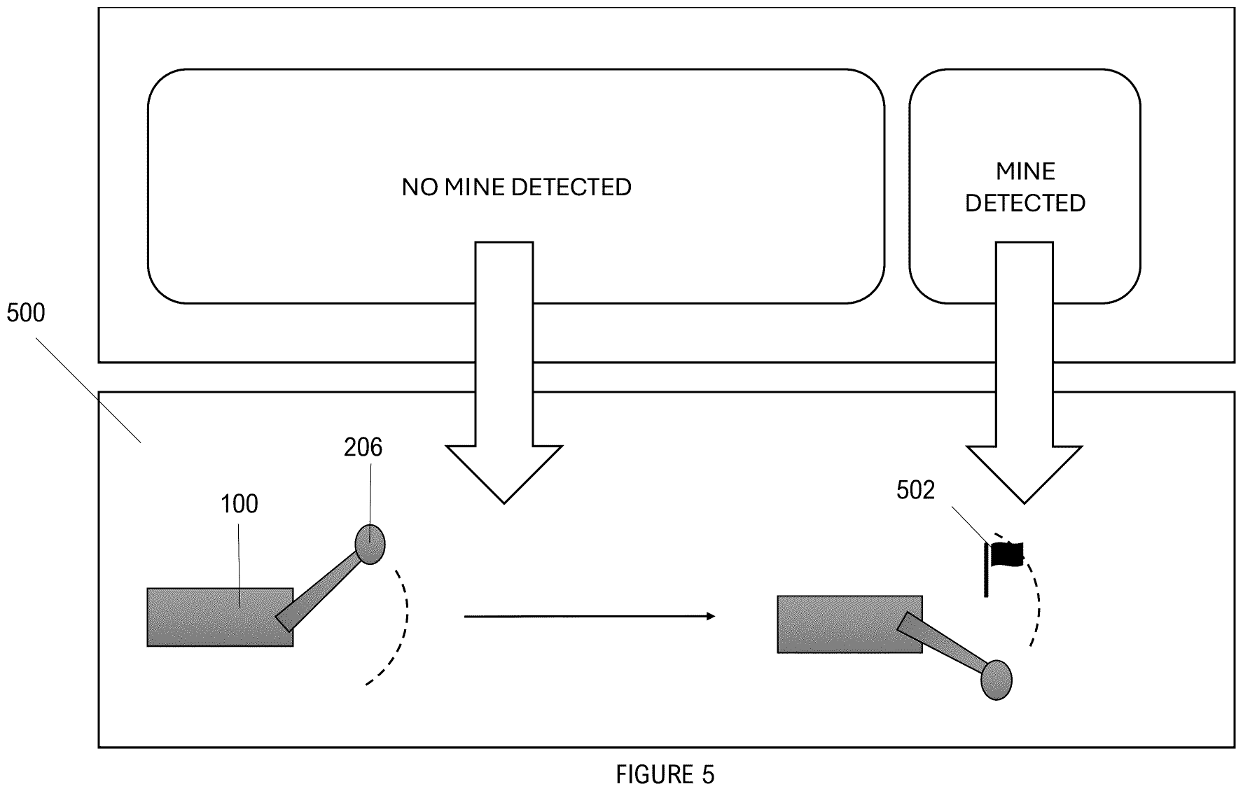

FIG. 5 depicts the robot's movement through a terrain with at least one landmine detected. In accordance with the preferred embodiment of the present invention, the robot 100 may traverse a designated area of terrain 500 in search for landmines. The robot 100 may sweep an arm with an end-effector (for example, a gripper with a land-mine detecting device or other useful end-effector) 206 in front of the robot 100 in order to detect landmines prior to locomoting across potentially dangerous terrain. If a landmine is detected, the robot may place a virtual marker 502, alerting a user of the landmine's location and enabling the robot 100 to continue forward while avoiding the area of interest containing the landmine. In this way, the marker 502 acts as a virtual obstacle through which the robot 100 will not traverse.

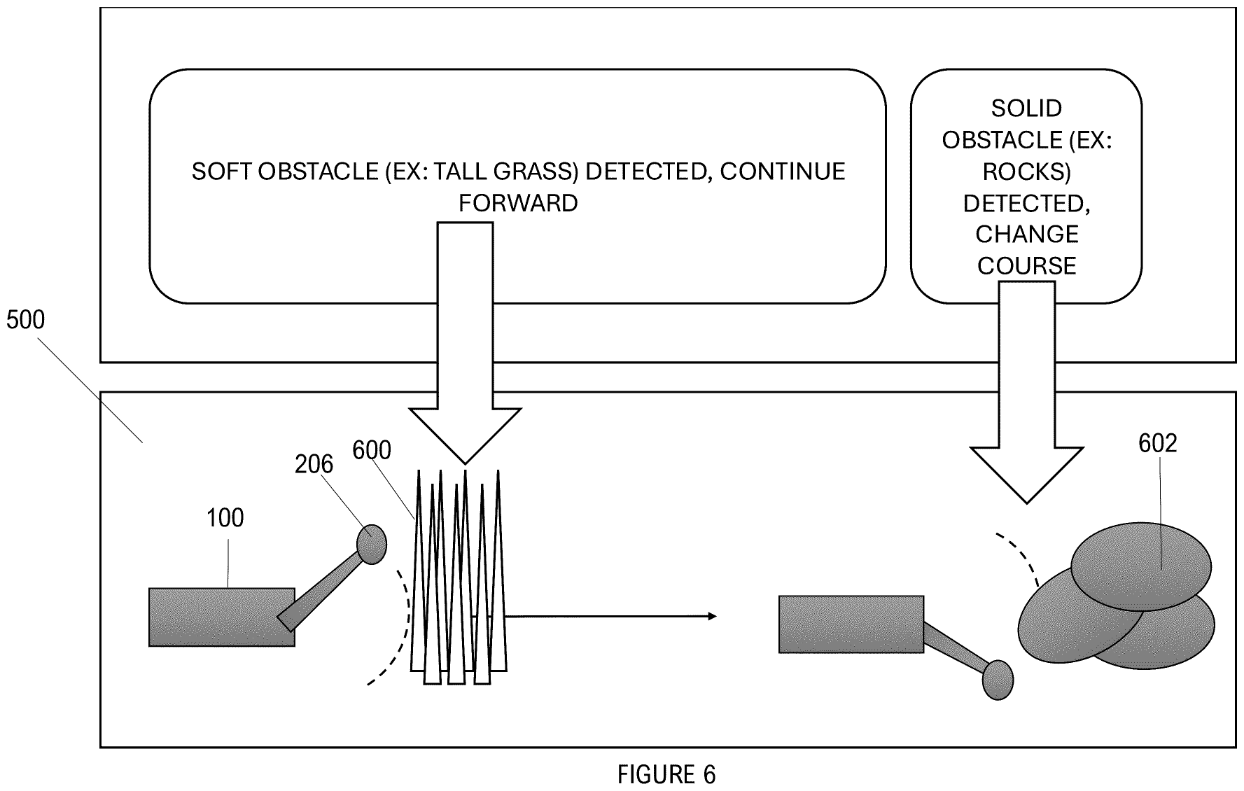

FIG. 6 depicts the robot's movement during detection of soft obstacles and solid obstacles. In accordance with the preferred embodiment of the present invention, when the robot 100 encounters an obstacle, the robot 100 must determine whether the obstacle is safe to traverse through, or if the obstacle must be avoided. The system presented should be configured to make such determination on its own, through a user may intervene and override a decision as to whether or not the robot 100 may continue forward if desired. Soft obstacles 600 such as grass, brush, or other obstacles which may be swept through, are deemed “soft” and the robot 100 may continue sweeping the end-effector 206 while advancing forward. Hard or solid obstacles such as rocks, trees, or other obstacles which the robot 100 would not be able to advance through are deemed “hard” or “solid,” and an alternate route forward is planned to avoid collision with the object and the end-effector. The alternate path accounts for the sweeping radius of the end-effector, so that any chance of collision with the obstacle is avoided from any angle.

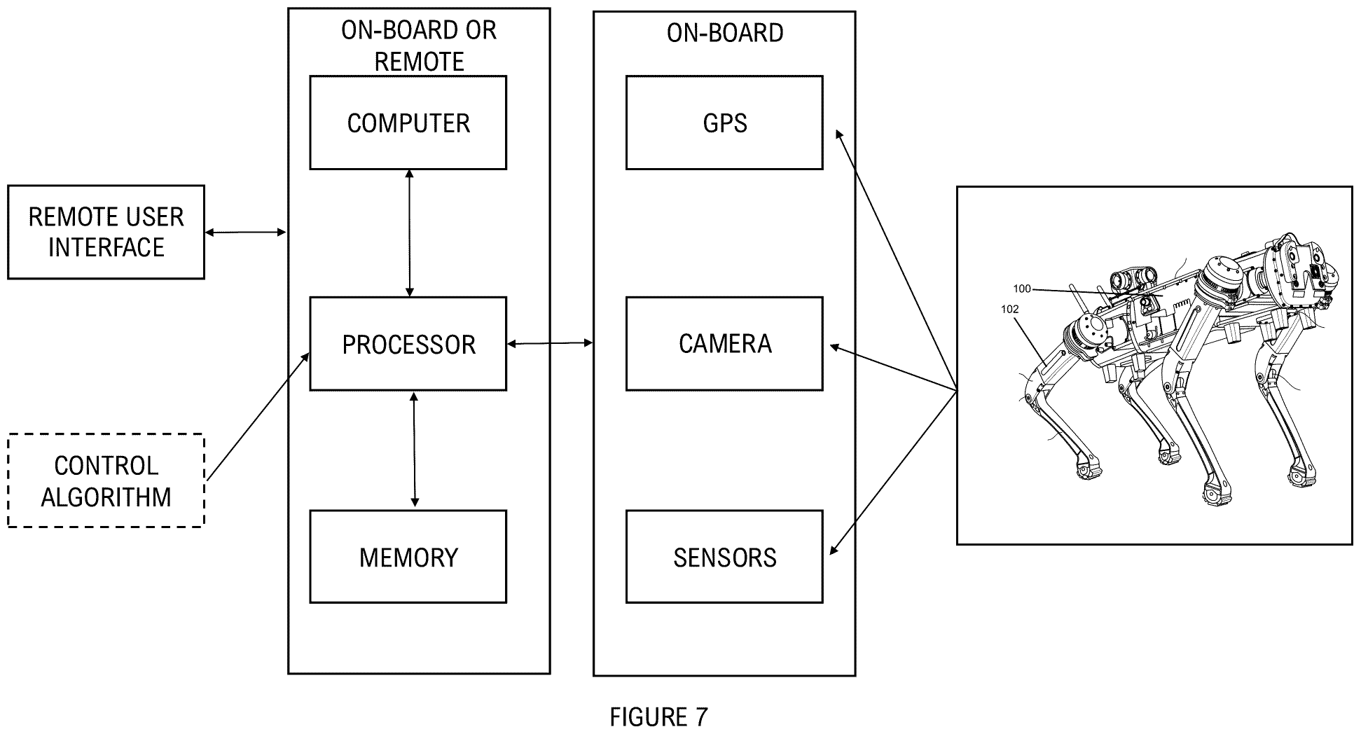

FIG. 7 depicts several components of the present invention. In accordance with the preferred embodiment of the present invention, the dynamical legged robot may be equipped with a plurality of sensors, at least one camera, and at least one global positioning system (“GPS”) or other navigation system. The sensors may include, but are not limited to, landmine-detecting devices, microphones, pressure sensors, temperature sensors, light sensors, infrared sensors, humidity sensors, accelerometers, ultrasonic sensors, etc. The on-board systems (including the navigation system, sensors, and cameras) are in communication with at least one processor, which is further in communication with at least one computer and at least one memory. Data collected from the on-board systems is sent to the processor and stored in the memory. Data may be accessed by a user via a user interface in communication with the on-board or remote systems including the computer, the processor, and the memory. A control algorithm may be located on the processor. The control algorithm generates commands based on feedback from the dynamical legged robot and the data collected by the on-board systems. Data collected may comprise image data from the cameras, location or other navigation data from the GPS or other navigation system, and other relevant data collected from a plurality of sensors. Information may be sent and received across the systems, for example, and not by way of limitation, a user may provide input regarding a request to detonate a detected landmine, and the request may be sent to the processor which communicates the request to the dynamical legged robot. Information regarding image or GPS data may be sent to the user interface to confirm actions or request input for decision-making. The sensors may be used to aid the dynamical legged robot in discriminating between various obstacles in a path of the robot. For example, the robot may discriminate between a “soft” obstacle such as brush or tall grass and a “hard” obstacle suck as a rock or a tree.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

What is claimed is:

1. A system for landmine detection and avoidance, said system comprising:
a dynamical legged robot comprising a robotic base, at least one robotic leg, at least one robotic arm, and at least one end-effector;
at least one processor in communication with said dynamical legged robot, wherein said at least one processor is configured to send and receive data to and from said dynamical legged robot;
at least one memory configured to store data received from said dynamical legged robot via said processor;
at least one control algorithm located on said at least one processor, wherein said control algorithm is configured to generate commands and send said commands to said dynamical legged robot; and
at least one user interface in communication with said at least one processor and said dynamical legged robot, wherein said at least one user interface is configured to:
receive input from a user;
send user input to said processor; and
receive data collected from said dynamical legged robot.

2. The system of claim 1, wherein said end-effector is a landmine-detecting device.

3. The system of claim 1, wherein said robotic arm is configured to move in a sweeping motion.

4. The system of claim 1, wherein, upon detection of a landmine, said dynamical legged robot marks a location of said landmine via a global positioning system (“GPS”).

5. The system of claim 1, wherein said data collected from said dynamical legged robot comprises image and GPS data.

6. The system of claim 1, wherein said dynamical legged robot is further configured to discriminate between soft obstacles and hard obstacles blocking a path of said dynamical legged robot.

7. The system of claim 1, wherein, upon a request from said user, said dynamical legged robot detonates a detected landmine.

8. A method for landmine detection and avoidance, said method
comprising: designating, via a global positional system (“GPS”), an area of terrain;
releasing a dynamical legged robot into said area of terrain, wherein said dynamical legged robot comprises a robotic base, at least one robotic leg, at least one robotic arm, at least one end-effector attached to said robotic arm, and at least one camera, and wherein said dynamical legged robot is configured to:
radially sweep said robotic arm in front of said dynamical legged robot;
collect data from said area of terrain;
place a virtual marker upon detection of a landmine via said GPS;
alert a user via a user interface of said detection of a landmine; and
upon receiving a request to detonate said landmine, apply pressure to an area above said detected landmine via said at least one robotic leg.

9. The method of claim 8, wherein said end-effector is a landmine-detecting device.

10. The method of claim 8, wherein said data collected from said dynamical legged robot comprises image and GPS data.

11. The method of claim 8, wherein said dynamical legged robot is further configured to discriminate between soft obstacles and hard obstacles blocking a path of said dynamical legged robot.

12. The method of claim 8, wherein said robot avoids a detected landmine via placement of virtual obstacles surrounding said detected landmine.

13. The method of claim 8, wherein said data is stored in a memory in communication with at least one processor.

14. The method of claim 13, wherein said at least one processor contains at least one control algorithm configured to generate commands and send said commands to said dynamical legged robot.

15. A system for landmine detection and avoidance, said system comprising:
a dynamical legged robot comprising a robotic base, at least one robotic leg, at least one robotic arm, at least one end-effector comprising a landmine-detecting device, a global positioning system (“GPS”) and at least one camera;
at least one processor in communication with said dynamical legged robot, wherein said at least one processor is configured to send and receive image and GPS data to and from said dynamical legged robot;
at least one memory configured to store data received from said dynamical legged robot via said processor;
at least one control algorithm located on said at least one processor, wherein said control algorithm is configured to generate commands and send said commands to said dynamical legged robot; and
at least one user interface in communication with said at least one processor and said dynamical legged robot, wherein said at least one user interface is configured to:
receive input from a user;
send user input to said processor;
receive data collected from said dynamical legged robot;
mark, via said GPS, a location of a detected landmine; and
send said mark to said user via said user interface.

16. The system of claim 15, wherein said at least one robotic arm is configured to move in a sweeping motion.

17. The system of claim 15, wherein said robot avoids a detected landmine via placement of virtual obstacles surrounding said detected landmine.

18. The system of claim 15, wherein said dynamical legged robot is further configured to discriminate between soft obstacles and hard obstacles blocking a path of said dynamical legged robot.

19. The system of claim 15, wherein, upon a request from said user, said dynamical legged robot detonates a detected landmine.

20. The system of claim 19, wherein said dynamical legged robot detonates said detected landmine via stomping said robotic leg.
